(19) United States
(12) Patent Application Publication
(10) Pub. No.: US 2016/0078381 A1
(43) Pub. Date: Mar. 17, 2016

(54) CAPACITY MANAGEMENT FRAMEWORK

(71) Applicant: BANK OF AMERICA CORPORATION, Charlotte, NC (US)

(72) Inventor: Michael D. Brownstein, Santa Clara, UT (US)

(21) Appl. No.: 14/485,137

(22) Filed: Sep. 12, 2014

(51) Int. Cl. G06Q 10/06

(52) U.S. Cl. CPC G06Q 10/06315

(57) ABSTRACT

Embodiments of the present invention provide apparatuses and methods for a capacity management tool that provides an end-to-end view of where a business process has come from, where the business process currently stands, and where the business process is going on an overall basis and a function-by-function basis within the business process. The capacity management tool of the present invention may be useful in many processes, including but not limited to processing different request volumes within a business for determining staffing levels for each function within the process as the request volumes change based on seasonal adjustments, time of day adjustments, events, staffing level changes, technology implementations, or the like. The capacity management tool can be sent to clients for various purposes, such as determining staffing levels when starting a new process, bringing a third party process within the business, sending a process to a third-party, or the like.

### FIELD

This invention provides a process and tool for optimizing the balance between supply and demand for production requirements. The process and tool are utilized to determine what resources are being used, where the resources are being used, when the resources are being used, and how the resources are being used.

### BACKGROUND

Monitoring and managing the capacity of production has been difficult in the past due to changes in production requirements for products and services over time, and the employees availability to work on meeting the production requirements.

### BRIEF SUMMARY

Embodiments of the present invention address the above needs and/or achieve other advantages by providing apparatuses (e.g., a system, computer program product, and/or other device) and methods for determining the demand for a process (e.g., volume to process, how long does each step within the process take, etc.) versus the supply for the process (e.g., the number of people available to handle the demand.). The capacity management tool of the present invention uses historical capacity information (e.g., supply and demand information) to provide current information regarding the supply and demand for processes within a business, and furthermore provides predictive capability for future supply and demand for processes within a business. The capacity management tool provides and end-to-end view of where a business process has come from, where the business process currently stands, and where the business process is going on an overall basis and a function-by-function basis within the business process. The capacity management tool of the present invention may be useful in many processes, including but not limited to processing different requests volumes (e.g., transaction request volumes, or other types of requests) within a business for determining staffing levels for each function within the process as the request volumes change based on seasonal adjustments, time of day adjustments, events, staffing level changes, technology implementations, or the like. The capacity management tool can be used within an institution or sent to clients of the institution, and it can be for various purposes, such as determining staffing levels when starting a new process, bringing an existing process previously performed outside of the business within the business, estimating costs for determining whether or not to use a third-party to perform a process, or the like. The capacity model is user friendly with limited inputs, but provides the capacity management information needed to make decisions regarding the capacity within an institution for handling functions within business processes.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level capacity management process flow, in accordance with one embodiment of the present invention;

FIG. 2 illustrates a capacity management process flow, in accordance with one embodiment of the present invention;

FIG. 3 illustrates a capacity input interface, in accordance with one embodiment of the present invention;

FIG. 4 illustrates a non-production time estimator, in accordance with one embodiment of the present invention;

FIG. 5A illustrates a portion of a capacity output interface, in accordance with one embodiment of the present invention;

FIG. 5B illustrates a portion of a capacity output interface, in accordance with one embodiment of the present invention;

FIG. 6 illustrates a capacity output graph, in accordance with one embodiment of the present invention; and

FIG. 7 illustrates a block system diagram for a reward account recommendation system environment, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses or institutions that take the place of or work in conjunction with the financial institution or bank to perform one or more of the processes or steps described herein as being performed by a financial institution or bank. Still in other embodiments of the invention the financial institution or bank described herein may be replaced with other types of businesses or institutions.

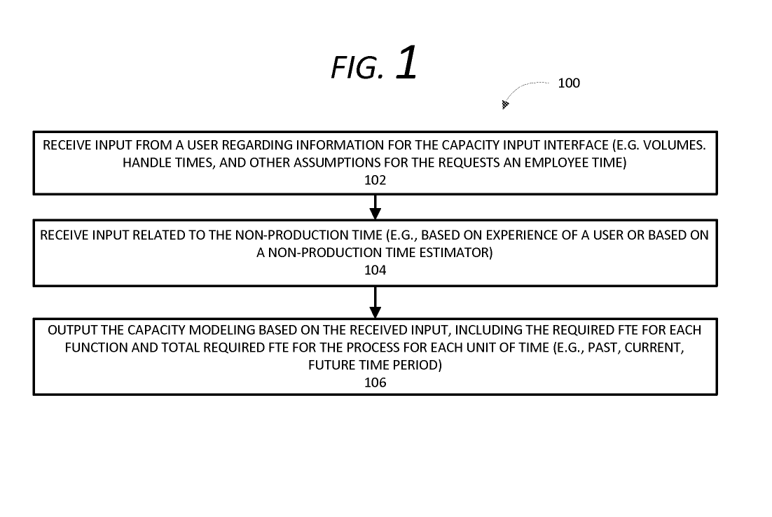

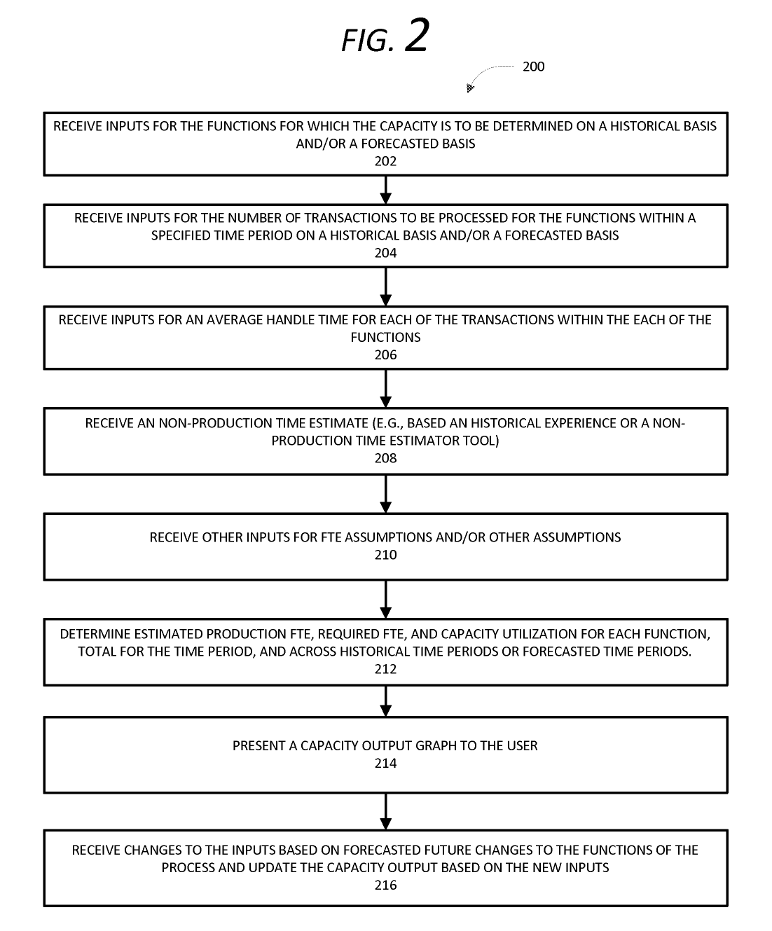

FIGS. 1 and 2 illustrate a high-level capacity management process and a specific capacity management process, in which an institution utilizes the capacity management tool, in accordance with embodiments of the present invention. The capacity management tool of the present invention may be tool that is used internally within an institution to determine the capacity associated with a process and/or functions within the process or it may be provided externally to other institutions for the same purpose. The institutions may be any type of institution, but in some embodiments the institution is a client of a financial institution that requests help from the financial institution regarding processes within the client's business.

As illustrated by block 102 in FIG. 1, the capacity management tool of the present invention receives input from a user 9 regarding information for a capacity input interface that allows the user 9 to manage the capacity of a process or groups of processes. The input, as will be explained in further detail later may be related to volumes of requests (e.g., requests for products or services) that require processing within a specific period of time, the handle times associated with processing the requests, available production time during the time period, and/or other assumptions which will be discussed in further detail below. Moreover, as illustrated by block 104 in FIG. 1, the capacity management tool of the present invention receives input from a user 9 regarding information for an estimated non-production time associated with an employee or group of employees. As explained in further detail later the non-production time is an estimation of the amount of time an employee spends doing work or non-work related activities that are not related to a specific business process or function within the process for which the capacity management tool is being used. Block 106 in FIG. 1 illustrates that the capacity management tool determines in response to the inputs, the outputs for the capacity supply and demand, and displays the outputs to the user 9, including the total required FTE, actual FTE, and capacity ratio for each function within a process and for the process overall.

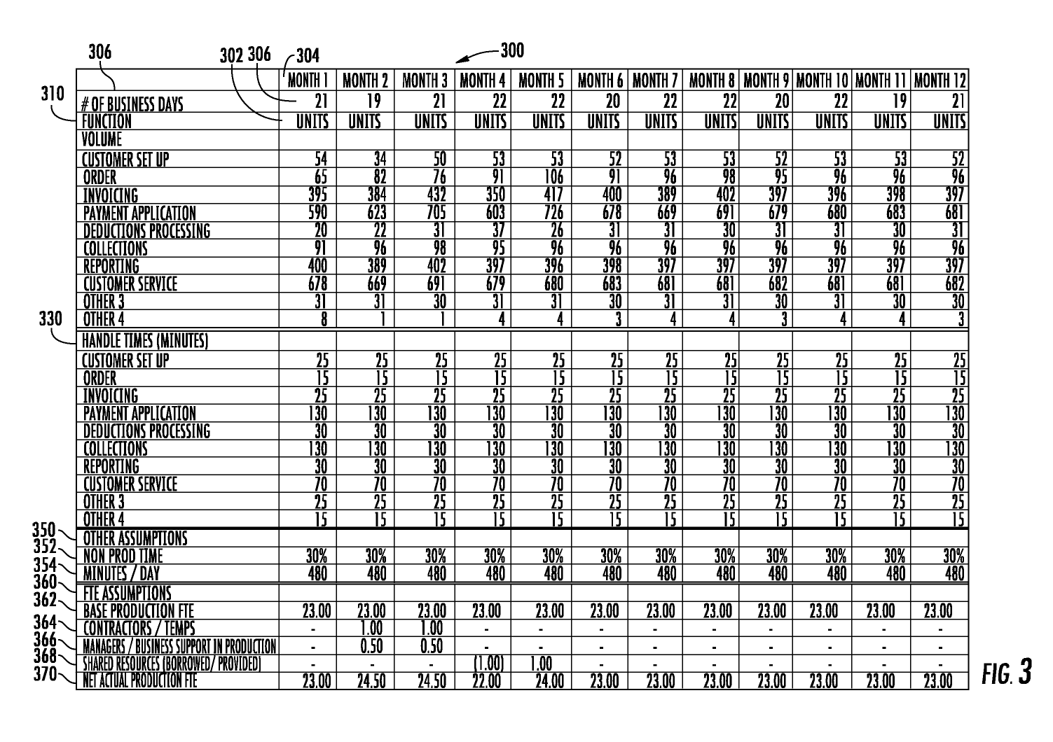

FIG. 2 provides a more detailed process flow for the capacity management process flow, in accordance with one embodiment of the present invention. As illustrated block 202 in FIG. 2, the capacity management tool (e.g., through the institution using the tool) receives user input related to the functions for a process or processes for which the capacity is being determined FIG. 3 illustrates one embodiment of a capacity input interface 300 for the capacity management tool where the user 9 inputs information related to the functions for the process of handling client requests. The capacity input interface 300 may have a volume section 310, a handle time section 330, other assumptions section 350, and a full-time employee (“FTE”) assumptions section 360, which may be populated by a user 9 and/or automatically by a system. The volume section 310 allows a user 9 to input the various functions of a business process (e.g., tests, process steps, applications used within the business process, or any other action that takes an employee or a system within the business an amount of time to work on).

Moreover, as illustrated by block 204, the capacity management tool receives inputs from the user 9 in the volume section 310 related to volumes associated with each of the functions or a time period 304. The volumes may be strategic volumes or operational volumes. The strategic volumes are the number of requests for services (e.g., client requests), measured by the products or services being processed by a line business within an institution. The operational volume is the number of activities required to process the requests for services. The operational volume may or may not have a one-to-one relationship with the strategic volume (e.g., one client request may require several operational activities, and alternatively client requests that have been automated may not be included because these requests may be handled automatically, and thus not require employee time). As such, for each function within the process, as illustrated in FIG. 3, the user 9 would input the number of units 302 (e.g., a transaction requests, or other count of what is being requested or activities needed to process the request, or the like) for each function entered into the capacity management tool. The user may enter the volume for each time period 304 (e.g., a month) for which the user has historical data, or for which the user is forecasting future volumes. As such, a user 9 may input volumes for one or more past time periods (e.g., historical data), current time periods (e.g., time period in which the institution is currently operating), and future time periods (e.g., forecasted time periods to determine future capacity). FIG. 3 illustrates the time periods 304 as a month, however, in other embodiments of the invention the time periods 304 may be a second, a number of seconds, a minute, a number of minutes, an hour, a number of hours, a day, a number of days, a month, a number of months, a year, a number of years, any combination thereof, or any other time period interval that can be used to measure capacity. As illustrated in the capacity input interface 300 the time periods 304 may be further broken down to sub-time periods 306, for example, the number of business days within the month, which may be helpful in determining the supply and demand capacity for the various functions within the process.

As an example of utilizing the capacity management tool, the capacity input interface 300 illustrates functions for processing different transaction requests within a business. As illustrated, the user 9 may input the functions of the process related to various transaction requests, such as customer set up, ordering, invoicing, payment application, deductions processing, collections, reporting, customer service, and other tasks which may cover the aggregate of miscellaneous tasks that are associated with the process. The user 9 may also input the number of transactions that are processed for each function. For example, as illustrated in the capacity input interface 300 the user 9 enters that there are fifty-four (54) transactions associated with the customer set up function of the process, sixty-five (65) transactions associated with the ordering function of the process, three hundred ninety-five (395) transactions associated with the invoicing function of the process, and so on for the first month. This process may be repeated for other months that are in the past, current, or in the future. The future volumes may be estimated based on technology changes, seasonal changes, financial forecasts, sales projects, or the like as discussed in further detail later.

As illustrated by block 206 in FIG. 2, the user 9 may also enter the handle times for a single unit 302 (e.g., a single request such as a single transaction request) associated with each of the functions entered into the volume section 310. The handle times may be entered into a handle time section 330 within the capacity input interface 300. The handle time section 330 illustrates the amount of time it takes to complete a single unit 302 within each of the functions listed in the volume section 310. For example, with respect to the customer set up time it takes twenty-five (25) minutes to process one of the customer set up transaction requests out of the fifty-four (54) transactions listed in the volume section 310, while it takes fifteen (15) minutes to process one of the order transaction requests out of the sixty-five (65) units listed in the volume section 310, and so on as illustrated in FIG. 3.

As illustrated by block 208 and 210 in FIG. 2, the capacity management tool receives inputs from the user 9 related to other assumptions that may be helpful in determining the capacity for the functions of the process. FIG. 3 illustrates an other assumptions section 350 in which the user 9 may input information used in determining the capacity output associated with the functions of the process, such as non-production time 352 and available production time 354, and an FTE assumptions section 360, which may be utilized to determine the actual production FTE 370.

As illustrated in the other assumptions section 350 in FIG. 3 and as illustrated by block 208 in FIG. 2, the user 9 may input the actual non-production time 352, which is the average percentage of time that an employee spends on the job not directly associated with handling the requests for the functions of the process. For example, employees may be out of work on sick leave, vacation, paid breaks, meetings, training, projects unrelated to the functions of the process, or the like. On average the non-production time 352 may be approximately 30%, or may range from 10%-50%, 20%-40%, 25%-35%, or any other value or ranges that fall within, fall outside, or overlap any of these values or ranges. In some embodiments the non-production time 352 may be an estimated value chosen from the experience of the user 9.

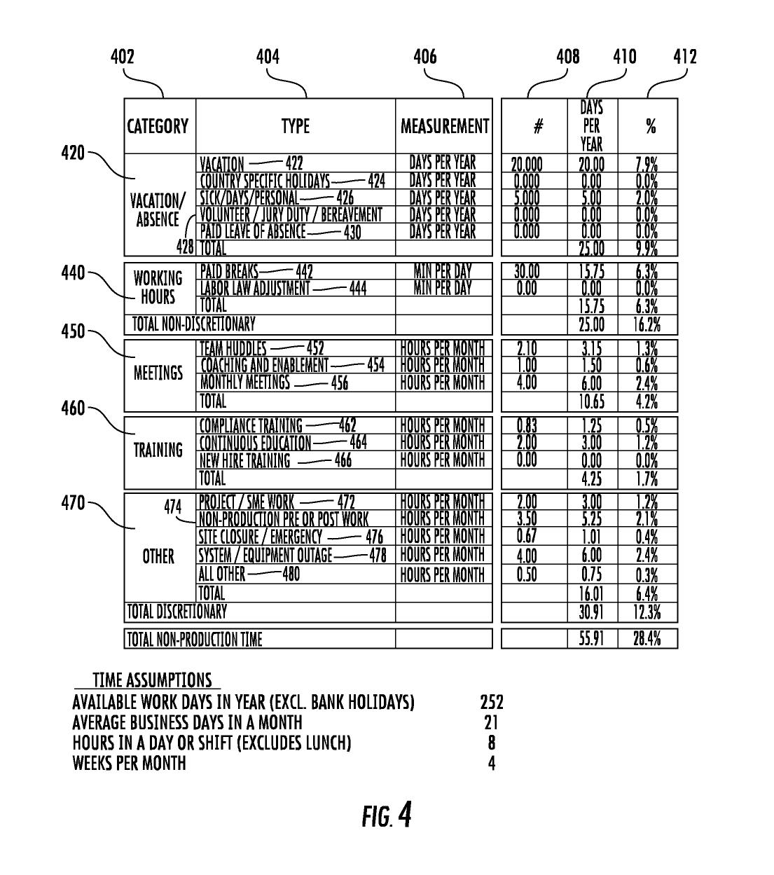

In other embodiments of the invention, the non-production time 352 may be determined based on inputs the user 9 enters into a non-production estimator interface 400, as illustrated in FIG. 4. The non-production estimator interface 400 may include categories 402 listing the categories of reasons why an employee may have non-production time; the types 404 of non-production times for each of the categories 402; the measurement value 406 for the categories 402 and types 404, the input 408 for the measurement value; a time normalizer 410 to convert the measurement value 406 to a value for the same time period (e.g., days per year, days per month, minutes per day, etc.) for all of the measurement values 406; and a non-production calculation 412 of the non-production time for each of the types 404 of non-production for each of the categories 402 (e.g., based on assumptions such as available work days in a year, average work days during the month, hours within a day, minutes within a day, or the like). The categories may include vacation/absence 420, working hours 440, meetings 450, training 460, and others 470.

The types of non-production time within the vacation/absence 420 category, may include vacation time 422, country specific holidays 424, personal time 426 (e.g., sick or other personal time), excused absence time 428 (e.g., volunteer, jury duty, bereavement), and paid leave of absence 430. The types of non-production time within the working hours category 440 may include paid breaks 442, labor law adjustments 444, or the like. The types of non-production time within the meetings category 450 may include team huddles 452, coaching and enablement 454, monthly meetings 456, or the like. The types of non-production time within the training category 460 may include compliance training 462, continuous education 464, new hire training 466, or the like. The types of non-production time within the others category 470 may include project or subject matter expert (SME) work 472, non-production pre or post work 474, site closure or emergency 476, system or equipment outage 478, and all other 480. As such, the non-production estimator interface 400 may be utilized to determine an average non-production time over all time periods 304, or a specific non-production time for particular time periods 304 within the input interface (e.g, for Month 1 vs. Month 2, or the like). In other embodiments of the invention, there may be other non-production types 404 and/or non-production categories 402 that may be utilized to determine a non-production time 352. As illustrated in FIG. 4 the non-production time indicator has calculated a non-production time of 28.4% (e.g., the employee is only really available for handling request 71.6% of the time out of the day, month, year, or other time period).

As illustrated in FIG. 3, the non-production time 352 may be the same for all of the inputs, or in other embodiments the non-production time 352 values may change for each time period 304. For example, the non-production time 352 may be greater in December and July when people often take vacations or businesses have paid holidays. The concept of the non-production time 352 may be described in a different manner through the term labor utilization rate, which is the amount of time the employee is available to work on production related to the request and is calculated as the difference between 100% and the non-production time 352. Continuing with the example provided in FIG. 4 non-production time would be 28.4%, while labor utilization rate would be 71.6%.

Returning to the other assumptions in the other assumptions section 350 in FIG. 3, and as illustrated by block 210 in FIG. 2, the user 9 may enter the available production time 354 per time period 304 into the capacity input interface 300. The available production time 354 (e.g., minutes per day, days per month, months per year, etc. during which the employee is at work) may be utilized to determine the amount of time available for a single employee to work on the functions of the process. For example, as illustrated in FIG. 3, the available production time 354 is entered as minutes per day, which is estimated as 480 minutes based on an eight (8) hour work day. In one embodiment the determination of the available production time 354 for an employee is based on assumptions such as the number of hours available during a single day and the average amount of time each employee works (e.g., this may be different for different countries, businesses, or the like). In other embodiments of the invention, instead of using minutes per day, other units of time are used to determine the capacity of the functions, such as weeks per month, average business days in a month, and available work days in a year, or the like.

Moreover, as illustrated by block 210 in FIG. 2 and the FTE assumptions section 360 in FIG. 3, the user 9 may also input or determine the actual production FTE 370, which is a determination of the number of employees who are directly involved in handling the requests associated with the functions of process. In one embodiment, the user 9 may simply input the actual production FTE 370 as an estimate. In other embodiments of the invention, the user may input a base production FTE 362, a contractors and/or temps FTE 364, a managers and/or business support FTE 366, a shared resources FTE 368, or other like FTE. The number of employees entered for one or more of these may include new employees for the portion of time they were actually involved in handling the requests for the functions during the time period 304 regardless of the productivity level of the new employees (e.g., this can be handled by the non-production time estimate discussed below). The base production FTE 362 is the core employees who are directly involved in the production of products or services in response to client demand. The contractors and/or temps FTE 364 is the temporary or contracted employees who are added on an interim basis to support the client demand. The managers and/or business support FTE 366 is the management or support employees that work on the functions to the extent that they are actually involved in the production time associated with the requests for the functions. The shared resources FTE 368 is a number of cross-trained employees either borrowed from other teams or lent out from this team (e.g., lent employees should be entered as a negative). These values add up to the actual production FTE 370.

As illustrated in FIG. 3, the actual production FTE 370 for the illustrated example is twenty-three (23) for the first time period 304 (e.g., first month), meaning there is the equivalent of twenty-three (23) full time employees available to handle the volume of requests for all of the functions in the process illustrated in FIG. 3. In some embodiments of the invention this actual production FTE 370 may change over the time periods 304 based on changes in the number of FTEs available per the time period 304 (e.g., changes in hiring, overtime, changes in technology, or the like during busy periods, etc.), as illustrated by the second time period 304 (e.g., second month), which includes an additional 1 FTE contractor, and a ½ FTE from the managers.

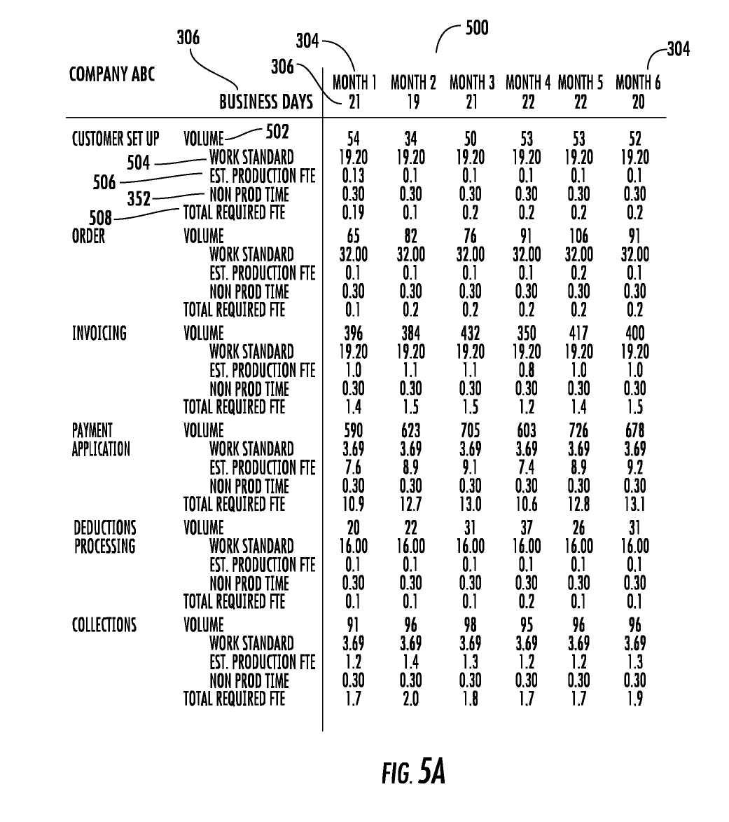

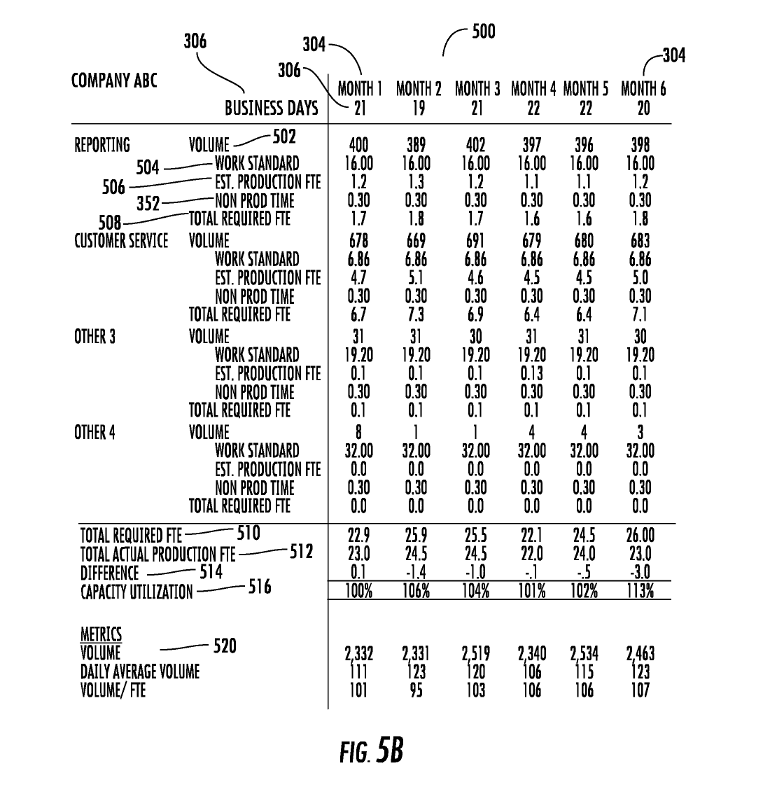

Once the inputs from block 202 to 210 of the present invention are received from the user 9 (or institution, or received form another system or application), then as illustrated by block 212 in FIG. 2 a determination is made of the estimated production FTE 506 and the total required FTE 508, and the capacity utilization 516 for the individual functions or for the entire process. FIGS. 5a and 5b illustrate the capacity output interface 500 that is provided after the capacity input interface 300 (and potentially the non-production estimator interface 400) is filled out by a user 9. As illustrated in FIG. 5a, for each process function the volume 502 (e.g. the strategic volume or operational volume) for each time period 304 is displayed. The work standard 504 illustrates the estimated output per day based on a standard workday (e.g., standard number of hours an employee has been hired to work each day, month, year, etc.). The work standard 504 illustrates number of transactions that can be done per associate per day. This work standard 504 does not include an allowance for non-production time, and it assumes the employees are working one-hundred (100) percent on handling requests and have one-hundred (100) percent labor utilization rate. For example, the customer set-up function illustrates that there were 54 transactions in the first month, and as such the work standard is 19.20 (e.g., 480 minutes divided by 25 minutes to complete one transaction), which indicates that 19.2 of the customer set-up transactions can be completed per day per employee.

Instead of or in addition to the work standard 504, a production standard (not illustrated in FIG. 5a or 5B) may also be determined, which is the estimated output per day based on the production time (e.g., the number of hours in a standard workday that are available to handle requests, such as produce goods or services, less the non-production time). The production standard may be used in forecasting staffing needs or evaluating labor performance The production standard includes an allowance for the non-production time 352, and as such it does not assume the employees are working 100% on handling request and it does assume less than 100% labor utilization rate.

The estimated production FTE 506 is also illustrated in the capacity output interface 500, and is a result of the operational volume multiplied by the production labor standard, which results in the number of employees that are required to meet the demand for handling the request volume. In another embodiment, the estimated production FTE 506 may be calculated by dividing the volume 502 per the time period 304 by the product of the work standard 504 and the sub-units of time 306. As illustrated in FIG. 5a, the estimated production FTE for the customer set up function is 0.13 FTE (e.g., 54 units per month/(19.2 units per day processed*21 days in the month)=0.13 estimated production FTEs per month).

The total required FTE 508 is an adjustment to the estimated production FTE 506 in order to account for the non-production time. As such, the total required FTE 508 is actually 0.19 FTE (e.g., 0.13/70% labor utilization, or 0.13/1-30% non-production time).

As illustrated by FIGS. 5a and 5b, the work standard 504, the estimated production time FTE 506, and the total required FTE 508 are determined for each function and for each time period 304 (e.g., each past time period, current time period, and future time period). As illustrated in FIGS. 5a and 5b the months may provide historical information, current information, or forecasted information (e.g., past time period may be months 1-4, current time period may be month 5, and future time period may be month 6) to determine how the transaction request processing for each function and the total process has changed over time and will change in the future. The capacity for each function may be aggregated to determine the total required FTE 510 for the process, which can be compared to the total actual production FTE 512 for each of the time periods 304 (e.g., past, current, or future time periods). The difference 514 in the required FTE 510 and the actual FTE 512 may be determined, and moreover the capacity utilization 516 may also be determined (e.g., ratio of request demand to FTE supply). The capacity utilization 516 may be determined by dividing the total estimated production FTE 510 by the production FTE 512. The capacity utilization can also be done for each function as opposed to the aggregated functions of the process. Moreover, the capacity variance may be determined to measure the ability to forecast the total estimated production FTE 510. The variance may be determined by dividing the actual estimated production FTE 512 by the forecasted total estimated production FTE 510 and subtracting 1.

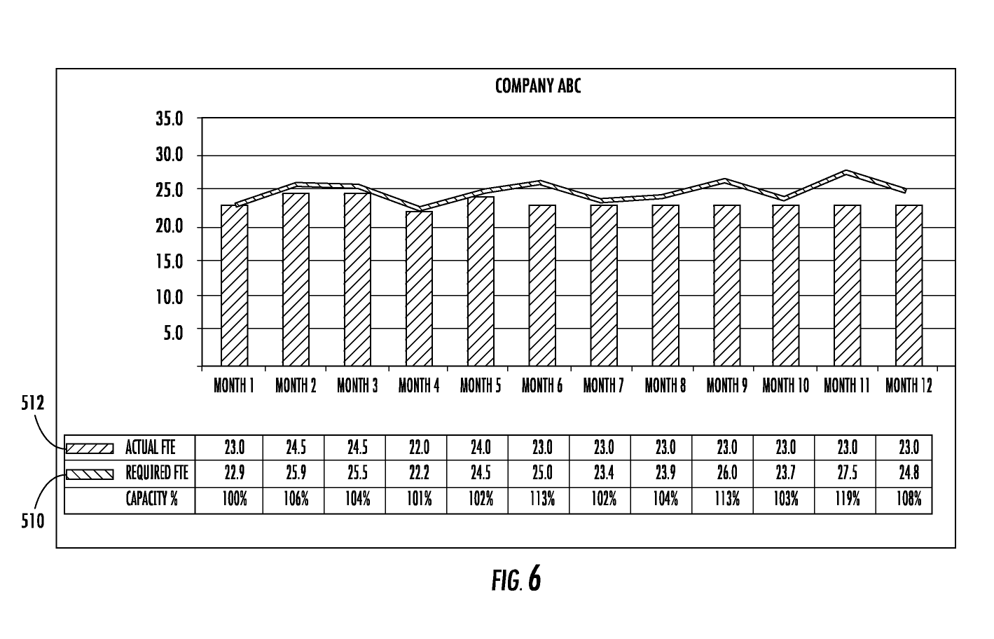

As illustrated by block 214 in FIG. 2, a capacity output graph 600 may be provided to the user 9 in place of or in addition to, the output interface 500. FIG. 6 illustrates the capacity output graph 600, which provides a visual display of the capacity over time and/or forecasted for the future. As illustrated in the capacity output graph 600, the total estimated production FTE 510 (e.g., required FTE) is illustrated along with the total actual production FTE 512 (e.g., actual FTE) for each time period 304. For example, as illustrated in FIG. 6 for the first month 22.9 FTEs were required to meet the actual request requirements and 23 FTEs were available to handle the requests. As such, with respect to the first month the capacity was just under full capacity or right at full capacity (e.g., 100%). In other months, with the exception of month 4 the actual FTEs did not meet the required FTEs, and as such the capacity was over full capacity. Other metrics may be presented in the capacity output interface 500 in a metrics section 520, such as but not limited to the total number of requests 522 (e.g., aggregate of the volumes of each function), the daily average volume 524 (e.g., aggregate of the volumes divided by the sub-units 306), and the average capacity FTE (e.g., aggregate of the volumes divided by the actual production FTE 512).

As illustrated by block 216 in FIG. 2, the inputs for the future time periods 304 may be adjusted in order to determine the forecasted capacity of the functions and the process based on changes to the processes or FTE supply. As such, the present invention allows an institution to model changes in the functions of the process based on changes to technology, employees, request volumes, or the like. For example, if the business was planning on purchasing a piece of technology or changing a process to eliminate a function of the process or otherwise changing the process to reduce (or increase) the average handle time associated with completing a function of the process, the present invention improves the ability to discover how such a change will impact the specific functions, the process in general, and the team of people available to handle the functions of the process. This capacity to handle the requests for each of the functions of the process plays a role in the costs associated with the process, and as such the capacity model can be used to transfer resources between functions within the process or between different processes (e.g., capacity models for different processes can be compared, or the functions within a process can be compared), or determining if the functions or process may be performed more efficiently by a third party.

This capacity management tool example discussed and illustrated herein with respect to FIGS. 3-6 is for a team of employees that are tasked with handing requests for functions within a process. It should be understood that the present example can be broken down to the employee level or rolled up to cover multiple processes. With respect to the employee level the present invention could be utilized to determine the capacity of each employee with respect to each function in the process. Tasks for each function within the process could be assigned based on how each employee handles particular functions, what employees are idle, what employees are above average in processing which functions, and which employees are below average in processing which functions, or the like.

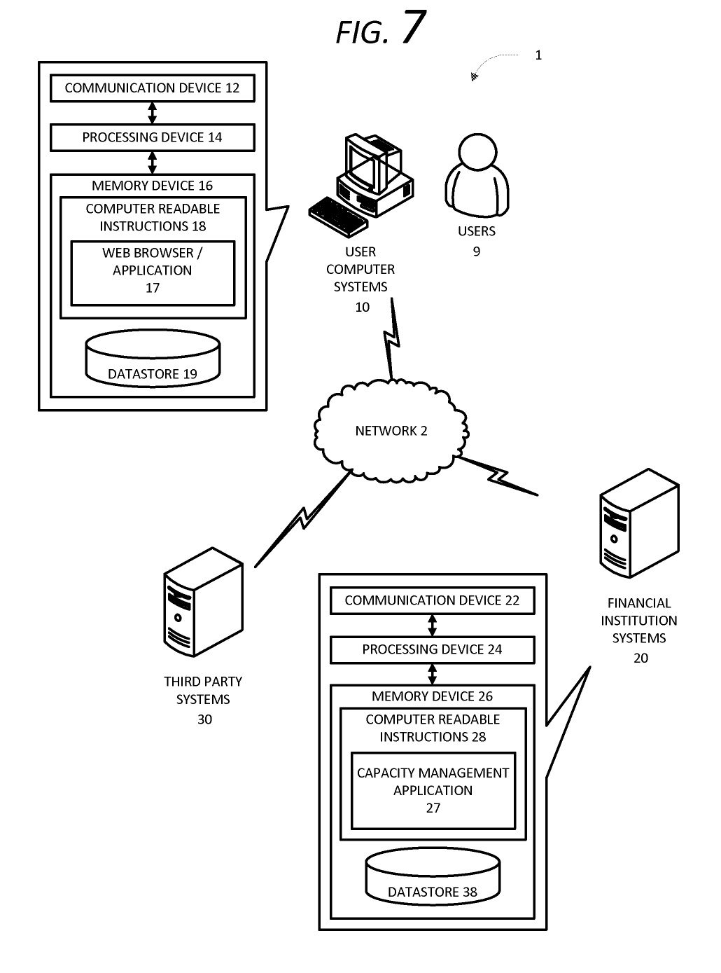

FIG. 7 illustrates a capacity management system 1, in accordance with an embodiment of the present invention. As illustrated in FIG. 7, the user computer systems 10 are operatively coupled, via a network 2 to the financial institution systems 20, and third-party systems 30. As discussed herein, in this way, the user computer systems 10 may be utilized by users 9 in order to access the capacity management application 27 (e.g., tool) stored on the financial institution systems 27, third-Party systems 30, or in some embodiments stored directly on the user computer systems 10. As previously noted the capacity management application 27 allows a user 9 to determine what resources are being used, where the resources are being used, when the resources are being used, and how the resources are being used. FIG. 7 illustrates only one example of embodiments of a capacity management system 1, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 7, the user computer systems 10 generally comprise a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device. The functions of the invention may be executed by a single processor or multiple processors.

The processing device 14 is operatively coupled to the communication device 12 and the memory device 16. The processing device 14 uses the communication device 12 to communicate with the network 2 and other devices on the network 2, such as, but not limited to, the financial institution system 20, or third-party systems 30. As such, the communication device 12 generally comprises a modem, server, or other device for communicating with other devices on the network 2, and a display, camera, keypad, mouse, keyboard, microphone, and/or speakers for communicating with one or more users 9. The user computer systems 10 may include, for example, a personal computer, a laptop, a mobile device (e.g., phone, smartphone, tablet, or personal display device (“PDA”), or the like) or other devices, or the like.

As further illustrated in FIG. 7, the user computer systems 10 comprise computer-readable instructions 18 stored in the memory device 16, which in one embodiment includes the computer-readable instructions 18 of a web browser or application 17. In some embodiments, the memory device 16 includes a datastore 19 for storing data related to the user computer systems 10, including but not limited to data created and/or used by the web browser or application 17. As discussed above the web browser or application 17 allows the users 9 to communicate with the capacity management application 27 (e.g., the capacity management tool, or the like), or other applications provided by the financial institution or third-party in order to provide capacity management information to the one or more users 9. In some embodiments a web browser is used to access websites, applications, or the like; however, in other embodiments a specific application (e.g., mobile application, computer application, or the like) is specifically configured to communicate with the other systems and applications within the capacity management system 1. In still other embodiments of the invention portions of other applications, or the other applications, may be stored on the user computer systems 10, such as but not limited to the capacity management application 27, or other applications.

As further illustrated in FIG. 7, the financial institution systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the user computer systems 10 and third-party systems 30. As such, the communication device 22 generally comprises a modem, server, or other device(s) for communicating with other devices on the network 2.

As illustrated in FIG. 7, the financial institution systems 20 comprise computer-readable program instructions 28 stored in the memory device 26, which in one embodiment includes the computer-readable instructions 28 of a capacity management application 27. In some embodiments, the memory device 26 includes a datastore 29 for storing data related to the financial institution systems 20, including but not limited to data created and/or used by the capacity management application 27. The capacity management application 27 (e.g., the capacity management tool, or the like), as discussed above, receives information related to supply and demand for processes within a business, and furthermore provides predictive capability for future supply and demand for processes within a business.

As further illustrated in FIG. 7, the third-party systems 30 are operatively coupled to the user computer systems 10 and financial institution systems through the network 2. The third-party systems 30 have devices that are the same as or similar to the devices described for the user computer systems 10 and financial institution systems 20 (e.g., communication device, processing device, memory device with computer-readable instructions, datastore, or the like). Thus, these systems communicate with each other and the user computer systems 10 in the same or similar way as previously described with respect to the user computer systems 10 and financial institution systems 20. The third-party systems 30 in some embodiments may include a portion of or the entire, capacity management application 27 that receives information related to supply and demand for processes within a business, and furthermore provides predictive capability for future supply and demand for processes within a business. In other embodiments the third-party systems 30 provide capacity information for the capacity management application 27 (e.g., provide information to financial institution or other third-party). In some embodiments the users 9 are associated with the third-party (e.g., employee, associate, contractor, agent, or the like) an in other embodiments the users 9 are associated with the financial institution (e.g., employee, associate, contractor, agent, or the like).

It is understood that the systems and devices described herein illustrate one embodiment of the invention. It is further understood that one or more of the systems, devices, or the like can be combined or separated in other embodiments and still function in the same or similar way as the embodiments described herein (e.g., the processing devices, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.’

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for managing capacity of a process within a business based on historical capacity and forecasting future capacity using full-time employee (FTE) values, the system comprising:
one or more memory devices; and
one or more processing devices operatively coupled to the one or more memory devices, wherein the one or more processing devices are configured to execute computer-readable program code to:
receive inputs for a plurality of functions within a process;
receive inputs for a number of requests associated with each of the plurality of functions within the process for at least a past time period and at least a future time period;
receive inputs for an average handle time for a single request for each of the plurality of functions within the process for at least the past time period and at least the future time period;
receive at least one non-production time percent estimate for the plurality of functions within the process for at least the past time period and at least the future time period;
receive at least one average available production time for the plurality of functions within the process for at least the past time period and at least the future time period;
receive at least one actual production FTE value for the plurality of functions within the process for at least the past time period and at least the future time period;
determine a required FTE value for each of the plurality of functions within the process for at least the past time period and at least the future time period, wherein the required FTE value for each of the plurality of functions is determined using the number of requests, the average handle time, the at least one non-production time percent estimate, the at least one average available production time, and the at least one actual production FTE; and
provide the required full-time employee value for each of the plurality of functions within the process for at least the past time period and at least the future time period to a user.

2. The system of claim 1, wherein determining the required FTE value for each of the plurality of functions comprises determining an estimated production FTE by:
determining a work standard for the plurality of functions within the process for at least the past time period and at least the future time period, wherein the work standard is equal to the average production time for the time period divided by the average handle time; and
determining the estimated production FTE for the plurality of functions within the process for at least the past time period and at least the future time period, wherein the estimated production FTE for the plurality of functions is equal to the number of requests divided by a product of the work standard and the average available production time.

3. The system of claim 2, wherein determining the required FTE value for each of the plurality of functions comprises:
determining a labor utilization rate by taking a difference between one-hundred percent and the non-production time percent estimate; and
dividing the estimated production FTE by the labor utilization rate.

4. The system of claim 1, wherein the non-production time percent estimate is determined based on a non-production estimator, and wherein the one or more processing devices are configured to execute computer-readable program code to:
receive input for the non-production estimator for an amount of vacation time, absence time, paid leave time, meeting time, training time, and work time unrelated to the request on average for an employee; and
determine the non-production time percent estimate based on the vacation time, the absence time, the paid leave time, the meeting time, the training time, and the work time unrelated to the request.

5. The system of claim 1, wherein the one or more processing devices are further configured to execute computer-readable program code to determine a capacity utilization for the plurality of functions within the process for at least the past time period and at least the future time period by:
determining a total required FTE by aggregating the required FTE for each of plurality of functions within the process for at least the past time period and at least the future time period; and
dividing the total required FTE value by the at least one actual production FTE for the plurality of functions within the process for at least the past timer period or at least the future time period.

6. The system of claim 1, wherein the inputs are altered for at least the future time period in order to forecast the future capacity changes for at least the future time period.

7. The system of claim 1, wherein the at least one actual production FTE comprises an actual production FTE for the for at least the past time period and a different actual production FTE for at least the future time period, and wherein the at least one actual production FTE is determined by receiving a base production FTE, a contractor and/or temps FTE, a managers or business support in production FTE, and/or a shared resources FTE.

8. A computer program product for managing capacity of a process within a business based on historical capacity and forecasting future capacity using full-time employee (FTE) values, the computer program product comprising at least one non-transitory computer-readable medium having computer-readable program code portions embodied therein, the computer-readable program code portions comprising:
an executable portion configured for receiving inputs for a plurality of functions within a process;
an executable portion configured for receiving inputs for a number of requests associated with each of the plurality of functions within the process for at least a past time period and at least a future time period;
an executable portion configured for receiving inputs for an average handle time for a single request for each of the plurality of functions within the process for at least the past time period and at least the future time period;
an executable portion configured for receiving at least one non-production time percent estimate for the plurality of functions within the process for at least the past time period and at least the future time period;
an executable portion configured for receiving at least one average available production time for the plurality of functions within the process for at least the past time period and at least the future time period;
an executable portion configured for receiving at least one actual production FTE value for the plurality of functions within the process for at least the past time period and at least the future time period;
an executable portion configured for determining a required FTE value for each of the plurality of functions within the process for at least the past time period and at least the future time period, wherein the required FTE value for each of the plurality of functions is determined using the number of requests, the average handle time, the at least one non-production time percent estimate, the at least one average available production time, and the at least one actual production FTE; and
an executable portion configured for providing the required full-time employee value for each of the plurality of functions within the process for at least the past time period and at least the future time period to a user.

9. The computer program product of claim 8, wherein the executable portion configured for determining the required FTE value for each of the plurality of functions comprises an executable portion configured for determining an estimated production FTE by:
determining a work standard for the plurality of functions within the process for at least the past time period and at least the future time period, wherein the work standard is equal to the average production time for the time period divided by the average handle time; and
determining the estimated production FTE for the plurality of functions within the process for at least the past time period and at least the future time period, wherein the estimated production FTE for the plurality of functions is equal to the number of requests divided by a product of the work standard and the average available production time.

10. The computer program product of claim 9, wherein the executable portion configured for determining the required FTE value for each of the plurality of functions comprises:
determining a labor utilization rate by taking a difference between one-hundred percent and the non-production time percent estimate; and
dividing the estimated production FTE by the labor utilization rate.

11. The computer program product of claim 8, wherein the non-production time percent estimate is determined based on a non-production estimator, and wherein the computer-readable program code portions further comprise:
an executable portion configured for receiving input for the non-production estimator for an amount of vacation time, absence time, paid leave time, meeting time, training time, and work time unrelated to the request on average for an employee; and
an executable portion configured for determining the non-production time percent estimate based on the vacation time, the absence time, the paid leave time, the meeting time, the training time, and the work time unrelated to the request.

12. The computer program product of claim 8, wherein the computer-readable program code portions further comprise:
an executable portion configured for determining a capacity utilization for the plurality of functions within the process for at least the past time period and at least the future time period by:
determining a total required FTE by aggregating the required FTE for each of plurality of functions within the process for at least the past time period and at least the future time period; and
dividing the total required FTE value by the at least one actual production FTE for the plurality of functions within the process for at least the past timer period or at least the future time period.

13. The computer program product of claim 8, wherein the inputs are altered for at least the future time period in order to forecast the future capacity changes for at least the future time period.

14. The computer program product of claim 8, wherein the at least one actual production FTE comprises an actual production FTE for the for at least the past time period and a different actual production FTE for at least the future time period, and wherein the at least one actual production FTE is determined by receiving a base production FTE, a contractor and/or temps FTE, a managers or business support in production FTE, and/or a shared resources FTE.

15. A method for managing capacity of a process within a business based on historical capacity and forecasting future capacity using full-time employee (FTE) values, the method comprising:
receiving, by a processing device, inputs for a plurality of functions within a process;
receiving, by a processing device, inputs for a number of requests associated with each of the plurality of functions within the process for at least a past time period and at least a future time period;
receiving, by a processing device, inputs for an average handle time for a single request for each of the plurality of functions within the process for at least the past time period and at least the future time period;
receiving, by a processing device, at least one non-production time percent estimate for the plurality of functions within the process for at least the past time period and at least the future time period;
receiving, by a processing device, at least one average available production time for the plurality of functions within the process for at least the past time period and at least the future time period;
receiving, by a processing device, at least one actual production FTE value for the plurality of functions within the process for at least the past time period and at least the future time period;
determining, by a processing device, a required FTE value for each of the plurality of functions within the process for at least the past time period and at least the future time period, wherein the required FTE value for each of the plurality of functions is determined using the number of requests, the average handle time, the at least one non-production time percent estimate, the at least one average available production time, and the at least one actual production FTE; and
providing, by a processing device, the required full-time employee value for each of the plurality of functions within the process for at least the past time period and at least the future time period to a user.

16. The method of claim 15, wherein determining the required FTE value for each of the plurality of functions comprises determining an estimated production FTE by:
determining a work standard for the plurality of functions within the process for at least the past time period and at least the future time period, wherein the work standard is equal to the average production time for the time period divided by the average handle time; and
determining the estimated production FTE for the plurality of functions within the process for at least the past time period and at least the future time period, wherein the estimated production FTE for the plurality of functions is equal to the number of requests divided by a product of the work standard and the average available production time.

17. The method of claim 16, wherein determining the required FTE value for each of the plurality of functions comprises:
determining a labor utilization rate by taking a difference between one-hundred percent and the non-production time percent estimate; and
dividing the estimated production FTE by the labor utilization rate.

18. The method of claim 15, wherein the non-production time percent estimate is determined based on a non-production estimator, and wherein the method further comprises:
receiving, by a processing device, input for the non-production estimator for an amount of vacation time, absence time, paid leave time, meeting time, training time, and work time unrelated to the request on average for an employee; and
determining, by a processing device, the non-production time percent estimate based on the vacation time, the absence time, the paid leave time, the meeting time, the training time, and the work time unrelated to the request.

19. The method of claim 15, further comprising:
determining, by a processing device, a capacity utilization for the plurality of functions within the process for at least the past time period and at least the future time period by:
determining a total required FTE by aggregating the required FTE for each of plurality of functions within the process for at least the past time period and at least the future time period; and
dividing the total required FTE value by the at least one actual production FTE for the plurality of functions within the process for at least the past timer period or at least the future time period.

20. The method of claim 15, wherein the inputs are altered for at least the future time period in order to forecast the future capacity changes for at least the future time period.
